(19) United States
(12) Patent Application Publication
(10) Pub. No.: US 2005/0125281 A1
(43) Pub. Date: Jun. 9, 2005

(54) Scheme leveraging knowledge gained of a customer's computer system to suggest possible products and services of interest

(76) Inventors: David L. Henrickson, Hialeah, FL (US); Christa St. Pierre, Fort Lauderdale, FL (US); Zijad F. Aganovic, Boca Raton, FL (US)

Correspondence Address: Gregory P. Gadson, Esq., 19375 Amber Way, Noblesville, IN, 46060, US

(21) Appl. No.: 10/731,571

(22) Filed: Dec. 9, 2003

(51) Int. Cl. G06F 17/60

(52) U.S. Cl. 705/10

(57) ABSTRACT

A comprehensive and flexible computer replacement scheme allows a user/customer to order a new replacement computer, and have the new computer delivered having installed thereon, a migrated “user state” from a source computer, and updated versions (and also suggested software predicted to be of interest to the user/customer) and upgrades of user state components with the aid of a Replacement Assistant software tool. The updates and upgrades, etc. include newer versions of application software, newer versions of operating systems, and even hardware and peripheral devices that differ from the hardware or peripheral devices of the source computer. Adapted for use by computer and software vendors and merchants, the Replacement Assistant controls the migration, upgrade and purchase processes. The Replacement Assistant can be operated remotely (online), locally at the business or home of the user/customer, or in-person at a merchants store, etc.

### BACKGROUND OF THE INVENTION

1. Field of the Invention

The present invention broadly relates to schemes for ordering and delivering new computer systems and other electronic devices. The present invention also relates to improvements in computer migration methods in the environment of purchasing a new computer via a computer system and software retailing or vending entity.

2. Background

Computer migration may be broadly defined as the process of transferring some or all of a “source” computer's information, non-device assets or intellectual property, to a “target” computer. The computer migration process is often carried out via a special computer migration tool kit in the form of software loaded on the source computer, the target computer, or both. The two computers involved in the migration process can be linked in a variety of ways, including, inter alia, direct cables/wires, direct telephone links, Local Area Networks (LANs), and Wide Area Networks (WANs). Alternatively, another approach is to use an intermediate storage device or system (e.g., rewritable or write-once CDs, ZIP® storage devices, network storage, etc.) to which to transfer aspects of the source computer. The aspects to be migrated are then transferred from the intermediate device to the target computer.

With rapid advancements in the computing power and memory capacity of widely available desktop computers, as well as others, the practical life cycle of computer systems continues to decrease. While users continue to switch to newer computer systems, there is very often a need and desire to transfer important aspects of the old computer system to the new computer system. As newer generations of computer systems also offer new generations of software and peripherals, such as video and photography accessories, printers, storage, communication gear for local networks and Internet access, etc., those complexities of the new systems often make users fearful and reluctant to make a change. The fear of migration is perceived by many retailers as the single largest inhibitor of potential computer sales.

There are several prior art approaches to computer migration, each having drawbacks. A “brute-force” approach entails painstakingly transferring software, data and other aspects of a source computer to a target computer in a piece-meal fashion. This method is tedious, extremely slow, and often requires a level of sophistication not possessed by ordinary computer users who wish to transfer important aspects from one computer to another computer.

Software such as the Alohabob's™ PC Relocator software marketed by Eisenworld, Inc., the assignee of this Letters Patent, solves many migration problems by transferring all of the important aspects (the “user state” described infra.) of the source computer—including applications, preferences and settings, and data—to the target computer, while giving the user the option to leave behind potentially troublesome (to the target computer) aspects of the source computer. The software has a unique capability to scan and analyze the source computer, and to identify all information objects that can be migrated. The aforementioned Alohabob's™ PC Relocator software and others marketed by Eisenworld, Inc. are believed to uniquely transfer to the target computer during the migration process, the complete “user state” of the source computer comprising applications and data, user settings pertaining to both software installed on the source computer, the source computer hardware, and those pertaining to peripheral devices (e.g., printers, scanners, external drives, displays and others) coupled to, or expected or capable of being coupled to the source computer.

Following a successful migration of the user state of an “old” computer to a “new” computer, users often find that while the components and aspects of the components of the user state may have been optimal for the old computer, they may not all be optimal for the performance of the new computer. For example, the new computer may have a more current operating system and newer versions of application software more desirable to use. Even if newer application software is not already resident on the new computer, newer application software may nonetheless exist, and a user desiring newer application software would then have to separately install the newer application software at a later time after receiving the necessary software in the future. Likewise, newer versions of the application programs of interest to the user might also exist that are not part of the user state, which would require subsequent steps (including often purchasing the software at a store and then physically installing it) at a later time by the user to install on the new computer. Customers purchasing replacement computers that are expected to have migrated components from and old computer might also be interested in hardware or peripheral upgrades that exist for a particular computer model before the sale for the new computer is complete.

In summary, there is an unfilled need to enhance existing migration tool capabilities with smart PC Replacement Assistant agent technology (discussed infra.) to provide a scheme for migrating the user state of a source computer to a target computer, while contemporaneously giving the user a mechanism for installing or causing to be installed, newer compatible versions of source computer or target computer software if desired, and newer (than the target computer) hardware or peripheral upgrades if desired. There is also a great unmet need to address the aforementioned needs in a manner that provides additional commercial benefits to computer software and hardware vendors, manufacturers and retailers, at the time a new computer is purchased.

There is also an unmet need to create smart, self-help agent software able to assist computer users in restoring a “healthy” application state during the lifetime of target machine by using general migration state capabilities and applying them to repair the individual application state.

### SUMMARY OF THE INVENTION

In view of the aforementioned problems and deficiencies of the prior art, the present invention provides a custom computer acquisition method at least including: a) causing the contents of a source computer to be surveyed; b) from the surveying, gaining knowledge of the components of the source computer; c) acquiring knowledge of a plurality of upgrade products which at least contain an upgrade over one or more components of the source computer; d) receiving an order for a new target computer from a customer having dominion over the source computer; e) recommending to the customer, at least one upgrade product to be installed on the target computer based upon knowledge of the source computer components and knowledge of the upgrade products; f) enabling the customer to choose at least one upgrade product to be installed on the target computer; g) migrating to the target computer, the source computer components chosen by the customer to be migrated; h) installing the chosen upgrade products on the target computer; i) processing the order; and j) following elements h) and i), causing a custom target computer to be delivered to the customer or the customer's agent.

The present invention also provides a computer replacement system at least including a source computer, a target computer, a migration tool adapted to survey the source computer assets to establish a user state of the source computer, and an enhancement provider adapted to provide a user with at least one enhancement to at least one component in the user state not available on the source computer, wherein the migration tool is further adapted to, in response to user input, migrate the user state to the target computer, and in response to user input, contemporaneously install at least one enhancement on the target computer.

The present invention further provides a computer replacement method at least including providing a source computer, providing a target computer, surveying the source computer assets to establish a user state of the source computer, providing a user with at least one enhancement to at least one component in the user state not available on the source computer, in response to user input, migrating the user state to the target computer, and in response to user input, contemporaneously installing at least one enhancement on the target computer.

### BRIEF DESCRIPTION OF THE DRAWING FIGURES

Features and advantages of the present invention will become apparent to those skilled in the art from the description below, with reference to the following drawing figures, in which:

FIG. 1 is a first embodiment of the present-inventive computer replacement system with an online computer replacement assistant;

FIG. 2 is a second embodiment of the present-inventive computer replacement system with a locally distributed computer replacement assistant;

FIG. 3 is a third embodiment of the present-inventive computer replacement system with a computer replacement assistant initially loaded onto a target computer prior to delivery of the target computer;

FIG. 4 is a flow chart detailing the steps of the present-inventive computer replacement method used by a system such as the one shown in FIG. 1;

FIG. 5 is a flow chart detailing the steps of the present-inventive computer replacement method used by a system such as the one shown in FIG. 2;

FIG. 6 is a flow chart detailing the steps of the present-inventive computer replacement method used by a system such as the one shown in FIG. 3;

FIG. 7 is a representation of the steps in the present-inventive business method for purchasing a new computer with migrated components from an old computer and upgrades of the customer's choice installed; and

FIG. 8 is a representation of the steps in the generalized marketing method of the present invention.

### DESCRIPTION OF THE PREFERRED EMBODIMENTS

Computer Replacements Migration and Upgrades

The present invention is partially an improved scheme for migrating the user state from a source computer to a new computer acting as a target computer. The user state is analogous to a comprehensive “snapshot” of a system which reveals the details needed to construct the current status of a system. The user state includes components such as the operating system (although the operating system itself is not migrated), application files, data files, and user settings and preferences which may also be described as a user's “personality.”

The present invention also gives a user or customer the option to install on the target computer, current or more up-to-date versions of software in the user state when these versions exist. Another improvement is to allow a user or customer ordering a new computer to replace an old one that will have components migrated to the new one, to choose more current or up-to-date versions of hardware or peripherals that are compatible with the new computer. For example, if the operating system of the source computer is Windows 98®, a customer ordering a new computer will be given the option to purchase a new computer with later versions of the Windows® operating system such as Windows XP®, including any updates and patches. As another example, if more recent versions exist of the application software (e.g., Microsoft Office) in the user state, the user or customer can be given the option to have a more recent version installed on the target computer.

The present invention therefore not only includes an enhanced migration method, but also includes a method of ordering a new computer expected to supersede an old computer, in which the new computer will have installed all of the user state of the old computer, except those components that the customer chooses (with the aid of the Replacement Assistant infra.) not to transfer, and those components for which the customer has chosen to have updated versions installed.

Both the ordering and migration processes can be carried out using a novel online software tool referred to as a “Replacement Assistant.” Alternatively, the Replacement Assistant can be loaded on the source and target computers using a storage device such as a compact disc (CD). Or, the Replacement Assistant can be already loaded on a new target computer, and can guide the customer through the migration process. In all cases the Replacement Assistant has (or has access to) versions of popular software that may be of interest to customers wishing to purchase new computers and migrate information from old computers. The newer versions of software or hardware can be either loaded for direct operation by the new computer, or the newer software (and perhaps some hardware) chosen can be activated subsequently by online contact with an administering website, or via telephone (either automated or using live operators).

The present-inventive Replacement Assistant can therefore be administered by computer retailers, manufacturers, software vendors, etc., or combinations of such entities using approaches ranging from a completely automated online approach for ordering the new computer and migration, to in-person contact at “brick and mortar” operations where the customer might take in a migration file stored on a storage medium for onsite transfer to the newly purchased computer, to more do-it-yourself approaches where the customer purchases, along with a new computer, software containing the Replacement Assistant to be used later by the customer.

The upgrades, and suggested newer software and other components which can be installed on the target computer can also be thought of generically as “enhancements.” The term “upgrade” means any component that either enhances an existing component, or is a later version of an existing component, or is a component not present on the source computer that enhances the new target computer's operation (either compared with the source computer operation or the target computer operation or expected target computer operation without the upgrade).

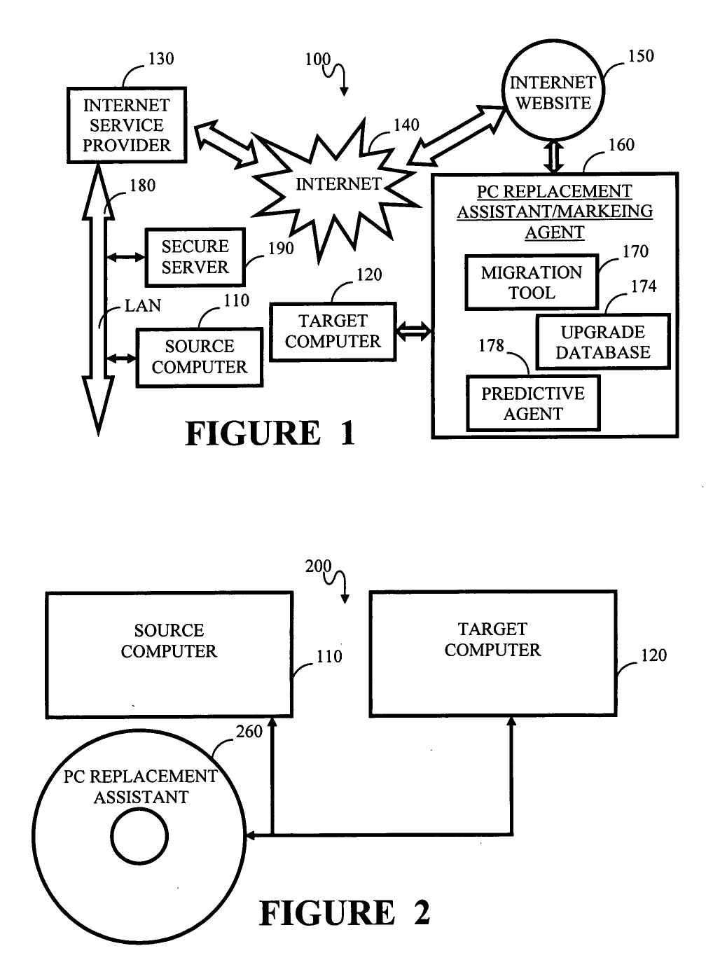

The first embodiment of the present-inventive target computer acquisition and migration system 100 is shown in FIG. 1. In the system 100 a source computer 110 can connect to a wide area network 140 such as the Internet, and then to a website 150 able to facilitate both the order and purchase of a new (“target”) computer 120, and the migration of the source computer user state to the target computer.

A Replacement Assistant 160 effects both the migration operation and the ordering of the new computer 120 in the preferred embodiment. Also in the preferred embodiment, the Replacement Assistant is capable of operating with different types of computers such as those of the PC and Macintosh varieties. In an alternate embodiment, a separate Replacement Assistant can be dedicated for various types of computer systems (e.g., a separate one for PCs and a separate one for “Macs”). The Replacement Assistant 160 includes a 1o migration tool 170 used to control the migration process, including scanning the source computer for components, presenting the components to the customer for the customer to decide which components will be transferred, and migrating the chosen components to the target computer (or to a temporary migration file before subsequently transferring the components to the target computer).

Additional information on migration tools can be found in U.S. Pat. No. 6,625,622 issued to David Henrickson et al. and assigned to the assignee of this Letters Patent for “APPARATUS AND METHOD FOR TRANSFERRING INFORMATION BETWEEN PLATFORMS,” which patent is hereby incorporated by reference. A further discussion on scanning the source computer, classifying source computer components, and migrating the user state to the target computer can be found in U.S. patent application Ser. No. 10/094,251 filed Mar. 8, 2002 for “NON-SCRIPT BASED INTELLIGENT MIGRATION TOOL CAPABLE OF MIGRATING SOFTWARE SELECTED BY A USER, INCLUDING SOFTWARE FOR WHICH SAID MIGRATION TOOL HAS HAD NO PREVIOUS KNOWLEDGE OR ENCOUNTERS,” which is also assigned to the assigned of this Letters Patent.

The Replacement Assistant 160 also contains an upgrade database 174 with links to sources for a number of versions of popular software as well as hardware components. The upgrade database 174 can be constructed to include generally available software, or limited to only upgrades immediately available through the sponsoring merchant.

A predictive agent 178 coupled to the migration tool 170 and the upgrade database 174 can be configured to suggest other software and hardware to the customer based upon a perceived potential interest and based upon a categorization of the components of the user state by the migration tool. For example, the user state may include a particular type of graphics arts application software that may have no upgrades beyond what is already in the user state. However, newer graphic arts applications may exist with similar functionality and are therefore presented to the customer for his/her possible selection.

The Replacement Assistant 160 is therefore a comprehensive tool to direct the migration process, the selection of upgrades and other features of interest, and the purchase process (of the new computer and of upgrades and other software, etc.), and can be used for positive commercial advantage by merchants. In operation according to FIG. 1, a customer desiring to replace a source computer 110 with a target computer 120 connects to the Replacement Assistant 160 via an Internet website 150 and is guided through the migration and purchase processes.

Those skilled in the art will appreciate that other components may be required for a viable system, depending on the user's environment, such as a LAN 180, and a secure server 190.

Given the description of FIG. 1, those skilled in the art will appreciate that other versions of the purchase/migration/upgrade system can be constructed. For example, the system 200 of FIG. 2 may be used in a scenario where a user/customer purchases a new computer with the intent of migrating the user state from and old computer to the new one. The Replacement Assistant 260 is loaded onto the source computer 110 and target computer 120 from a storage medium such as a CD or set of CDs. The customer can therefore cause the migration and upgrade processes to be performed on the premises of a home or business. As was previously mentioned in connection with FIG. 1, the upgrades can be activated using telephone call and Internet session methods.

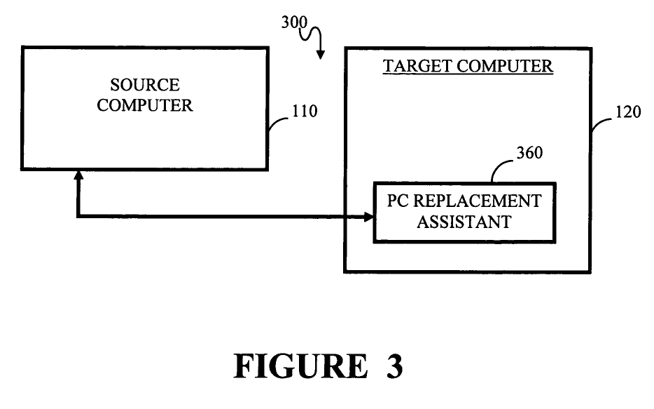

In yet another version of the present invention, a system 300 in FIG. 3 may be used under the scenario where the customer purchases a new computer having the Replacement Assistant 360 already preloaded on the new computer prior to delivery. The target computer 120 and the source computer 110 can be connected via cables or other communication links to effect the migration/upgrade processes.

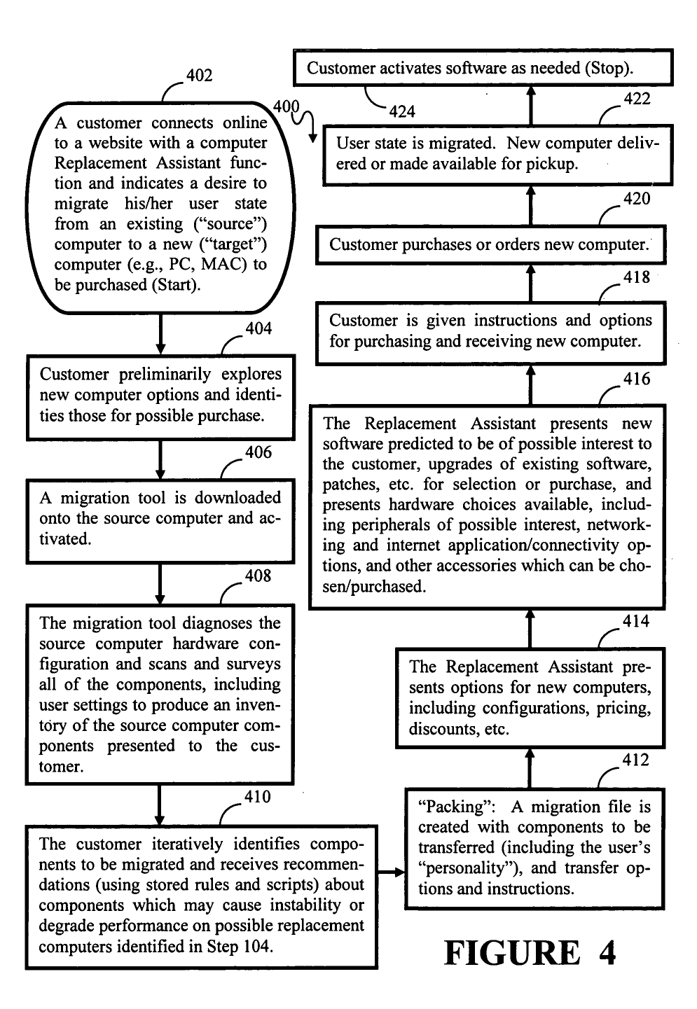

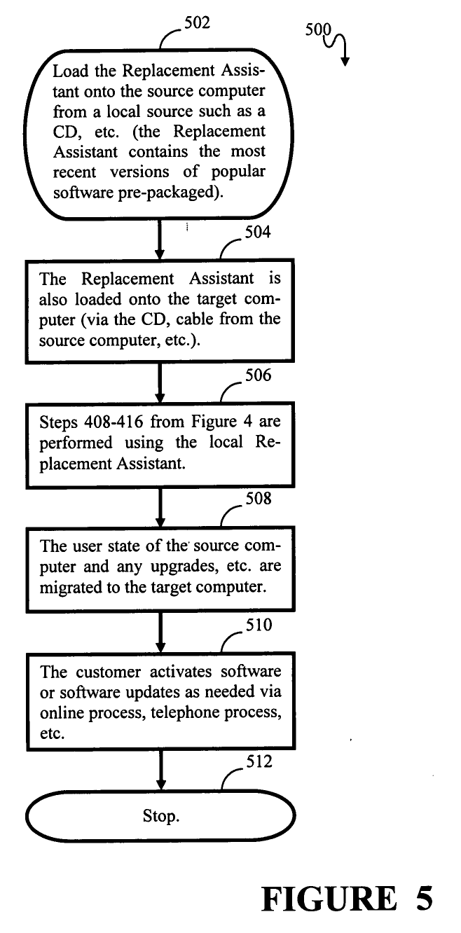

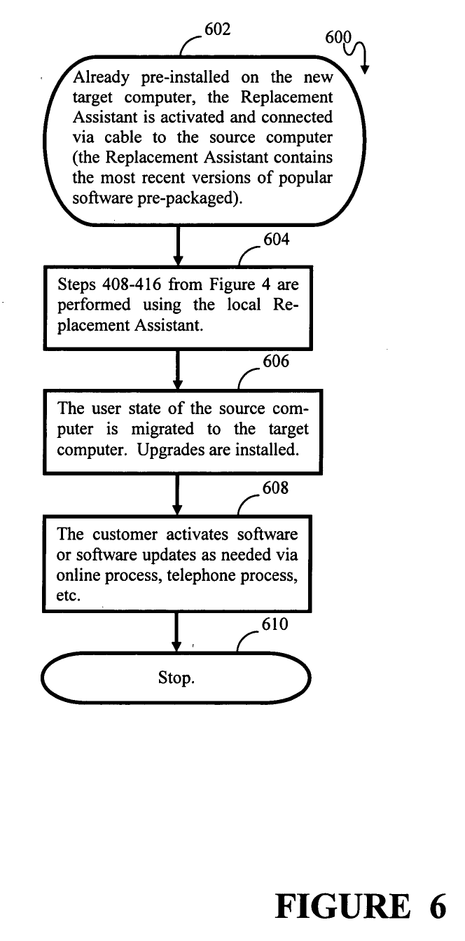

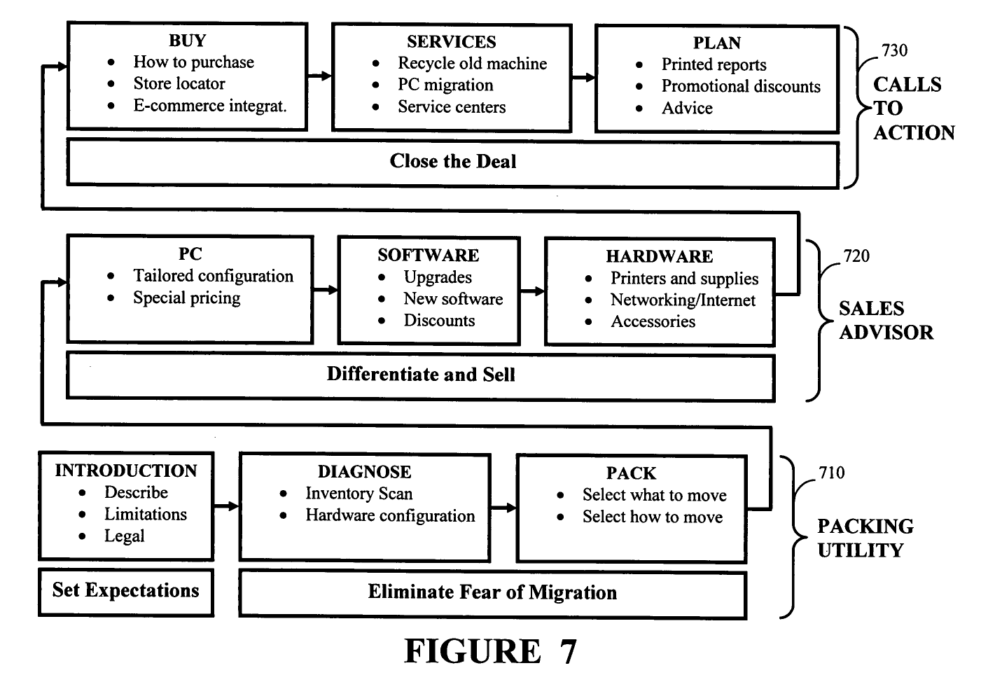

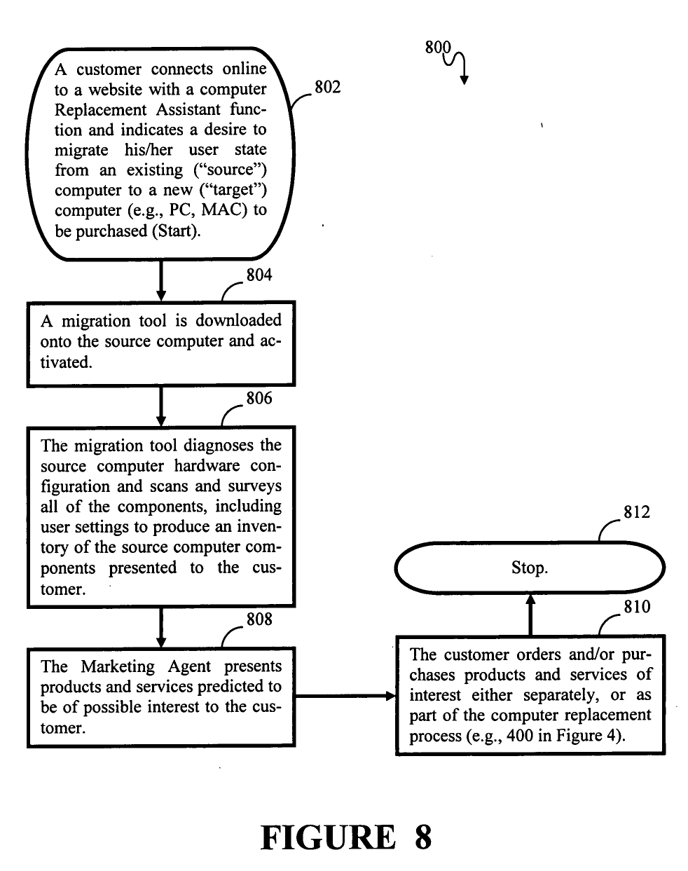

The method of the present invention as typified by the system of FIG. 1 is detailed in FIG. 4. To start the process (Step 402) a customer connects to a website having a Replacement Assistant function and indicates the desire to order a new computer and migrate the user state (or at least some of it) from an existing computer to the new one.

In Step 404, the customer preliminarily explores new computer options and identifies those for possible purchase. While not a necessary step, this gives the Replacement Assistant an idea of the resources/components that the new computer will be able to accommodate.

In Steps 406 and 408 the migration tool is downloaded onto the source computer and activated. The migration tool scans, surveys and inventories all of the components of the source computer comprising the user state, including user settings and user preferences. The migration tool directs the customer through the selection process of the actual components to be migrated based upon the migration tool's knowledge of the potential computers identified in Step 404 and its knowledge (rule based and script based) of the software to be transferred (Step 410).

The “Packing” step (412) involves placing the components to be migrated in a uniquely identified migration file for later migration to the new computer. The migration file is stored via online storage media (not shown), and can contain all of the components or for some more popular components, simply links to other locations.

In Step 414 the Replacement Assistant presents options for new computers to the customer, including pricing, discounts, configurations, etc. In Step 416 the Replacement Assistant also presents for the customer's consideration, available upgrades for detected software and other software and hardware predicted to be of possible interest (e.g., newer software versions, patches, hardware choices available, including peripherals of possible interest, networking and internet application/connectivity options, and other accessories).

The customer is given user-friendly instructions for ordering, purchasing and receiving a new computer in Step 418. The website can be linked to an e-commerce website or function for processing credit card purchases if needed. After the customer orders or purchases the new computer (Step 420), the user state and any upgrades or additional features and components purchased are transferred to the new computer for delivery to the customer (Step 422). Upon receipt of the new computer the customer activates any software as needed (Step 424).

FIG. 5 illustrates a process 500 used by a system such as the one 200 in FIG. 2. To start the process (Step 502) the customer (or merchant if the computer has been brought to the merchant) loads the Replacement Assistant onto the source computer from a local source such as a CD, etc. (the Replacement Assistant contains the most recent versions of popular software pre-packaged). The Replacement Assistant is also loaded onto the target computer (via the CD, cable from the source computer, etc.) in Step 504. The previously-described Steps 408 through 416 (FIG. 4) are performed using the local Replacement Assistant (Step 506).

The user state of the source computer and any upgrades, are migrated to the target computer in Step 508. The customer activates any software or software updates as needed via an online process or telephone, etc., as needed in Step 510. The process 500 ends in Step 512.

FIG. 6 illustrates a process 600 used by a system such as the one 300 in FIG. 3. To start the process (Step 602) the customer (or merchant if the computer has been brought to the merchant) activates the Replacement Assistant, which has been pre-installed on an already received new computer. The Replacement Assistant is loaded onto the source computer via cable, etc. from the new target computer.

The previously-described Steps 408 through 416 (FIG. 4) are performed using the local Replacement Assistant (Step 604).

The user state of the source computer and any upgrades, are migrated to the target computer in Step 606. The customer activates any software or software updates as needed via an online process or telephone, etc., as needed in Step 608. The process 600 ends in Step 610.

An overview of the business method subsumed by the present invention is shown in FIG. 7. The three main phases of the method are the Packing Utility phase 710, the Sales Advisor phase 720 and the Calls to Action phase 730. The steps are interactive, allowing a user to respond via a graphical user interface.

The first portion (“Introduction”) of the Packing Utility phase 710 is a series of user-friendly descriptions presented to the user via display screens which may include multimedia content that give an overview of the computer ordering, migration and upgrading and replacement processes, including limitations and legal issues or disclaimers. During the “Diagnose” portion of the Packing Utility phase the Replacement Assistant software scans and analyzes the source machine/computer, to enable it to then “pack” the user state for future migration during the “Pack” portion. Included are steps to learn which components may be safely migrated, giving the user the option to select which components to migrate, along with remembering those selected components or classes of selected components so that when the new target computer is connected (to the Replacement Assistant or directly to the is source computer), the migration process can continue from any previously paused point without the need to repeat any previous steps. This is referred to as storing a replacement plan on the source computer that can be later accessed by activating a specially-created icon on the source computer display. The replacement plan or parts thereof can also be printed.

During the Sales Advisor phase 720 the Replacement Assistant software analyzes the source computer profile and then applies pre-programmed rules to offer/present'to the user, software and hardware products it predicts will be most likely needed or desired by the user. More particularly, a “PC” portion of the Sales Advisor phase allows the user to tailor the configuration of the new computer and learn about any special pricing considerations. The “Software” portion of the Sales Advisor phase presents new software or upgrades of existing software predicted to be of interest, along with any discounts available. The “Hardware” portion is analogous to the “Software” portion, but involving printers, other peripheral devices and supplies for the new machine, networking/Internet options, accessories, etc. Driver software is also included in this phase. As was previously mentioned the software and hardware choices can be those immediately available through the sponsoring merchant, or available through other means, such as from a link to a software company's website.

The Replacement Assistant contains a rule-based engine designed to enable third party computer retailers and vendors to control sales offerings of computer systems and software. The engine establishes a general framework about how to classify users and how partners with the sponsoring merchant are to specify their sales offerings. For example, a scan of the source computer and information uploaded from the user might indicate that the user has a special interest in photography. The third party sponsoring merchant might be a retailer, for example, who can use the information from a user's newly established profile to offer him/her hardware and software with the new machine that are of interest to such a user, such as Photoshop™ software, an additional hard drive, special photography printers, and special rebate coupons. In this Example, the retailer can use a client software extension of the Packing Utility to control other offerings appropriate to the user/customer's classification. The ability of the retailer to provide the service using the Replacement Assistant can be part of promotional schemes which the retailer may charge to the participating vendors.

During the Calls to Action phase 730 of the method the Replacement Assistant software also provides all of the guidance the user/customer will need during the PC replacement process, including the options to easily find convenient store locations, purchase computer hardware and software online, and recycle the old machine. The “Buy” portion shepherds the user through the purchasing process, and includes any e-commerce operations necessary to complete financial transactions online. It also includes a store locator to provide the user with information about the nearest store for accepting delivery of the new machine.

The “Services” portion of the Calls to Action phase performs the important steps of migrating the user state of the source machine to the new target machine, as well as setting up the recycling of the old machine, and other services. As was previously mentioned, the Replacement Assistant software has the ability to accept the user's migration selections and complete the computer migration process including the specific user state selections. Also as previously mentioned, the Replacement Assistant installs and or activates software upgrades or new versions of software while preserving any settings on the source machine that pertain to the upgrade that the user has chosen to keep.

Recall that software installation and activation can be from multiple sources, including a centralized web site, an Unpacking Utility distributed on a storage medium such as CD ROM, or an Unpacking Utility pre-installed on the hard drive of the target machine. The Unpacking Utility also enables software license activation as needed for a fully functioning new target computer.

The end of the Calls to Action phase 730 is the “Plan” portion, providing the user with items such as promotional discounts for future transactions, printed reports if desired (for verification of the purchase, migration and upgrade operations), and any appropriate advice.

The use of the present-inventive Replacement Assistant can create a significant customer base by leveraging the detailed knowledge of customer profiles and user states created during computer replacement processes, and user state management technology. This knowledge and capability can be used for on-going computer maintenance service such as: application software upgrades, patches, etc.; and partial or full system restoration when computer viruses and the like render a customer's system unstable. For example, software patches to fix bugs and add enhancements can be installed not only during the migration process, but in the future on an on-going basis with end-user consent through online notification and delivery.

An extension of the on-going services can include a mechanism for allowing users who have previously used the Replacement Assistant to repair systems that have become corrupted or programs or other components which have become corrupted. For example, the Replacement Assistant can re-evaluate the user state of a former target computer and diagnose problems using the aforementioned rules-based approach and repair components as necessary (e.g., repair dynamic linking libraries (DLLs), and operating system libraries linking applications with the computer operating system).

General Marketing Approach

The present invention extends to the general case in which after scanning, surveying and inventorying a customer's computer system, the Replacement Assistant can, along with making recommendations for computer software and hardware, make general recommendations for products or services which are not necessarily computer-related. For example, the discovery of a large number of stored still pictures on the customer's computer might lead the Replacement Assistant (perhaps more aptly described here as a “Marketing Agent”) to present one or more cameras that the customer can purchase through the sponsoring merchant. As another example, the presence of stored audio files on a customer's computer might lead the Marketing Agent (160 in FIG. 1) to suggest several audio reproduction devices (such as MPEG3 players) for purchase. The Marketing Agent might suggest services as well based on the inventory of the customer's computer, and services that are either available through the sponsoring merchant, or services from a provider to which the sponsoring merchant can refer the customer. Endless possibilities for services include, for example, satellite and cable television subscriptions, digital radio service, and even services that are not related to electronics based upon a perceived potential interest by the customer.

The process 800 is illustrated in FIG. 8. As with the process 400 in FIG. 4, the process 800 begins when a customer connects to a website having a Replacement Assistant function and indicates the desire to order a new computer and migrate the user state (or at least some of it) from an existing computer to the new one (Step 802). In Step 804 the migration tool is downloaded onto the source computer and activated. The migration tool scans, surveys and inventories all of the components of the source computer comprising the user state, including user settings and user preferences (Step 806).

In Step 808 the Marketing Agent presents products and services to the customer predicted to be of possible interest based upon the results of Step 806 and its knowledge of available products and services. The customer can then separately order products or services, or order products and services as part of the computer replacement process (Step 810). The process stops in Step 812.

Variations and modifications of the present invention are possible, given the above description. However, all variations and modifications which are obvious to those skilled in the art to which the present invention pertains are considered to be within the scope of the protection granted by this Letters Patent.

For example, the novel teachings of the present invention can be utilized regardless of the size or complexity of the source and target computers (i.e., PC-to-PC migrations, mainframe-to-mainframe migrations, combinations or gradations of these, etc.).

1. A custom computer acquisition method comprising:
a) causing the contents of a source computer to be surveyed;
b) from said surveying, gaining knowledge of the components of said source computer;
c) acquiring knowledge of a plurality of upgrade products which at least contain an upgrade over one or more components of said source computer;
d) receiving an order for a new target computer from a customer having dominion over said source computer;
e) recommending to said customer, at least one upgrade product to be installed on said target computer based upon knowledge of said source computer components and knowledge of said upgrade products;
f) enabling said customer to choose at least one upgrade product to be installed on said target computer;
g) migrating to said target computer, the source computer components chosen by the customer to be migrated;
h) installing the chosen upgrade products on said target computer;
i) processing said order; and
j) following elements h) and i), causing a custom target computer to be delivered to said customer or said customer's agent.

2. The method of claim 1 wherein said source computer components comprise a user state.

3. The method of claim 1 further comprising:
downloading a software tool from a remote location onto said source computer; and
carrying out elements a) through i) with the aid of said software tool.

4. The method of claim 3 wherein said software tool is an instrumentality under the dominion of a computer software and hardware vendor.

5. The method of claim 1 further comprising:
loading a software tool onto said source computer; and
carrying out elements a) through i) with the aid of said software tool;
wherein said software tool is an instrumentality under the dominion of a computer software and hardware vendor, and wherein said upgrade products are directly available from said vendor.

6. The method of claim 1 further comprising:
loading a software tool onto said source computer; and
carrying out elements a) through i) with the aid of said software tool;
wherein said software tool is an instrumentality under the dominion of a computer software and hardware vendor, and wherein said upgrade products are available via an Internet link to an instrumentality of a separate entity from said vendor.

7. The method of claim 6 further comprising:
said computer software and hardware vendor receives remuneration from said separate entity when an upgrade product is received from said instrumentality of said separate entity.

8. The method of claim 1 further comprising:
loading a software tool onto said source computer from a local storage medium comprising said software tool and product upgrades; and
carrying out elements a) through i) with the aid of said software tool.

9. The method of claim 1 sans element j), wherein elements c) and d) are performed first, follow by causing a target computer to be delivered to said customer or said customer's agent, wherein said target computer comprises loaded thereon, a software tool and product upgrades, and said method further comprising carrying out elements a), b), e), f), g), h), and i) with the aid of said software tool.

10. The method of claim 1 further comprising:
activating at least one installed upgrade product via a telecommunication link.

11. The method of claim 1 wherein said upgrade products comprise software.

12. The method of claim 1 wherein said upgrade products comprise software.

13. A computer replacement method comprising:
a) providing a source computer;
b) providing a target computer;
c) surveying the source computer assets to establish a user state of said source computer;
d) providing a user with at least one enhancement to at least one component in said user state not available on said source computer;
e) in response to user input, migrating said user state to said target computer; and
f) in response to user input, contemporaneously installing at least one enhancement on said target computer.

14. The method of claim 13 further comprising:
implementing elements c) through f) via a remote, online link to an interactive software tool;
wherein said target computer is remote vis-à-vis said source computer, and said target computer is coupled to said interactive software tool.

15. The method of claim 13 further comprising:
implementing elements c) through f) via a locally installed interactive software tool.

16. The method of claim 13 further comprising:
implementing elements c) through f) via an interactive software tool pre-installed on a delivered target computer.

17. The method of claim 13, wherein said enhancements comprise newer operating system versions.

18. The method of claim 13, wherein said enhancements comprise newer versions of application software.

19. The method of claim 13, wherein said enhancements comprise newer versions of hardware.

20. The method of claim 13, wherein said enhancements comprise newer versions of peripheral devices.

21. The method of claim 13 further comprising:
providing a database of available enhancements; and
presenting at least one enhancement to said user which the user may choose for installation on said target computer.

22. The method of claim 13, further comprising:
analyzing the components of said user state;
predicting a possible interest by said user in at least one enhancement; and
presenting at least one enhancement predicted to be of possible interest to said user which the user may choose for installation on said target computer.

23. A marketing method comprising:
a) causing the contents of a customer's computer to be surveyed;
b) from said surveying, gaining knowledge of the components of said source computer;
c) acquiring knowledge of a plurality of products or services available through a sponsoring merchant; and
d) recommending to said customer for consideration and purchase, at least one product or service in c) based upon the knowledge gained in b).
